(19) United States
(12) Patent Application Publication
(10) Pub. No.: US 2013/0154993 A1
(43) Pub. Date: Jun. 20, 2013

(54) Method For Determining Coordinates Of Touches

(71) Applicant: Luben Hristov Hristov, Sofia (BG)

(72) Inventor: Luben Hristov Hristov, Sofia (BG)

(21) Appl. No.: 13/326,123

(22) Filed: Dec. 14, 2011

(51) Int. Cl. G06F 3/044; G06F 3/041

(52) U.S. Cl. 345/174; 345/173

(57) ABSTRACT

In one embodiment, a method includes receiving a first set of signal values from a touch sensor. The touch sensor includes a plurality of electrodes. The method includes storing the first set of signal values in a first two-dimensional array and determining a first one-dimensional representation associated with a first axis of the first two-dimensional array. The method includes determining a first area associated with at least one touch detected by the touch sensor from the first one-dimensional representation and determining a second one-dimensional representation associated with a second axis based on the first area, the second axis being different than the first axis. The method includes determining a second area associated with at least one touch detected by the touch sensor from the second one-dimensional representation and determining coordinates for the at least one touch detected by the touch sensor based on the first area and the second area.

### BACKGROUND

A touch sensor may detect the presence and location of a touch or the proximity of an object (such as a user's finger or a stylus) within a touch-sensitive area of the touch sensor overlaid on a display screen, for example. In a touch sensitive display application, the touch sensor may enable a user to interact directly with what is displayed on the screen, rather than indirectly with a mouse or touch pad. A touch sensor may be attached to or provided as part of a desktop computer, laptop computer, tablet computer, personal digital assistant (PDA), smartphone, satellite navigation device, portable media player, portable game console, kiosk computer, point-of-sale device, or other suitable device. A control panel on a household or other appliance may include a touch sensor.

There are a number of different types of touch sensors, such as (for example) resistive touch screens, surface acoustic wave touch screens, capacitive touch screens, optical touch screens (e.g., using infrared-based sensing). Herein, reference to a touch sensor may encompass a touch screen, and vice versa, where appropriate. When an object touches or comes within proximity of the surface of the capacitive touch screen, a change in capacitance may occur within the touch screen at the location of the touch or proximity. A touch-sensor controller may process the change in capacitance to determine its position on the touch screen.

Touch screens suffer from multiple issues. Many calculations must occur in order to accurately determine touch positions. Another issue is that screen response times are relatively long causing user interface and user experience problems.

### BRIEF DESCRIPTION OF THE DRAWINGS

Reference is now made to the following description taken in conjunction with the accompanying drawings, wherein like reference numbers represent like parts and which:

FIG. 1 illustrates an example touch sensor with an example touch-sensor controller;

FIG. 2 illustrates an example method for determining coordinates of one or more touches on a touch screen device using calculations on one-dimensional arrays of data; and

FIGS. 3A-3J illustrate an example of the operation of the method of FIG. 2.

### DESCRIPTION OF EXAMPLE EMBODIMENTS

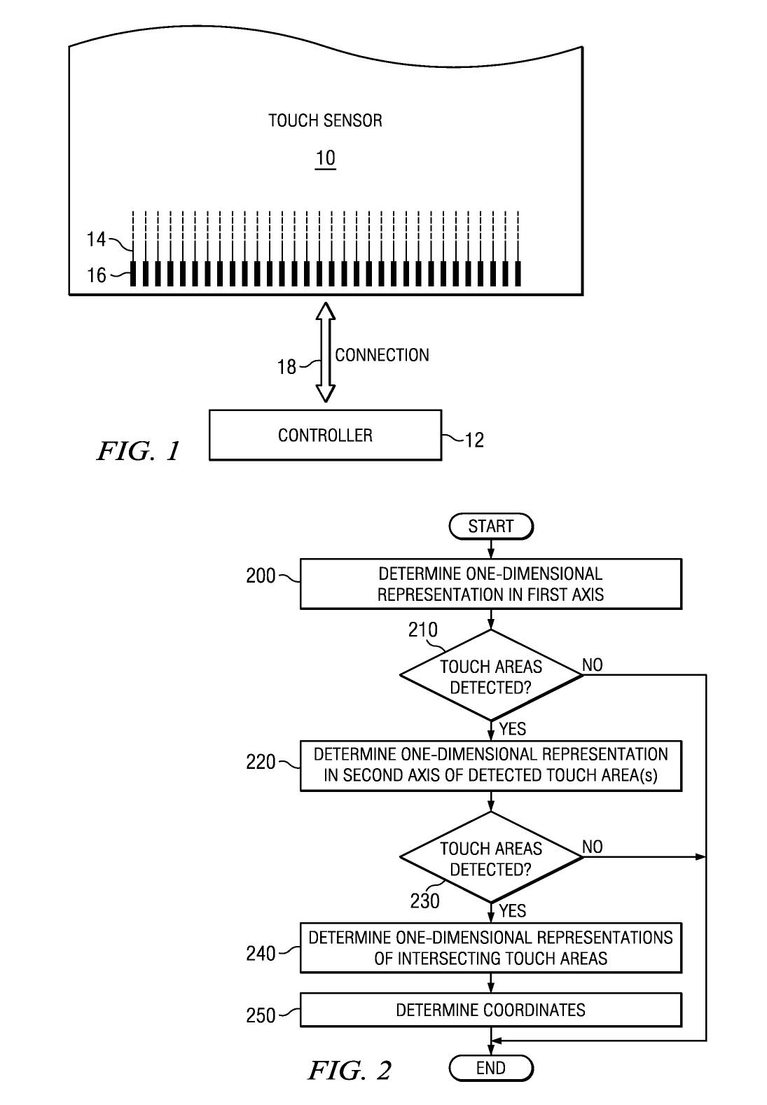

FIG. 1 illustrates an example touch sensor 10 with an example touch-sensor controller 12. Touch sensor 10 and touch-sensor controller 12 may detect the presence and location of a touch or the proximity of an object within a touch-sensitive area of touch sensor 10. Touch-sensor controller 12 may be configured to perform calculations on one-dimensional arrays of data regarding signals received from touch sensor 10 when determining the presence and location of one or more touches on touch sensor 10. Herein, reference to a touch sensor may encompass both the touch sensor and its touch-sensor controller, where appropriate. Similarly, reference to a touch-sensor controller may encompass both the touch-sensor controller and its touch sensor, where appropriate. Touch sensor 10 may include one or more touch-sensitive areas, where appropriate. Touch sensor 10 may include an array of drive and sense electrodes (or an array of electrodes of a single type) disposed on one or more substrates, which may be made of a dielectric material. Herein, reference to a touch sensor may encompass both the electrodes of the touch sensor and the substrate(s) that they are disposed on, where appropriate. Alternatively, where appropriate, reference to a touch sensor may encompass the electrodes of the touch sensor, but not the substrate(s) that they are disposed on.

An electrode (whether a drive electrode or a sense electrode) may be an area of conductive material forming a shape, such as for example a disc, square, rectangle, other suitable shape, or suitable combination of these. One or more cuts in one or more layers of conductive material may (at least in part) create the shape of an electrode, and the area of the shape may (at least in part) be bounded by those cuts. In particular embodiments, the conductive material of an electrode may occupy approximately 100% of the area of its shape. As an example and not by way of limitation, an electrode may be made of indium tin oxide (ITO) and the ITO of the electrode may occupy approximately 100% of the area of its shape, where appropriate. In particular embodiments, the conductive material of an electrode may occupy substantially less than 100% of the area of its shape. As an example and not by way of limitation, an electrode may be made of fine lines of metal or other conductive material (such as for example copper, silver, or a copper- or silver-based material) and the fine lines of conductive material may occupy substantially less than 100% of the area of its shape in a hatched, mesh, or other suitable pattern. Although this disclosure describes or illustrates particular electrodes made of particular conductive material forming particular shapes with particular fills having particular patterns, this disclosure contemplates any suitable electrodes made of any suitable conductive material forming any suitable shapes with any suitable fills having any suitable patterns. Where appropriate, the shapes of the electrodes (or other elements) of a touch sensor may constitute in whole or in part one or more macro-features of the touch sensor. One or more characteristics of the implementation of those shapes (such as, for example, the conductive materials, fills, or patterns within the shapes) may constitute in whole or in part one or more micro-features of the touch sensor. One or more macro-features of a touch sensor may determine one or more characteristics of its functionality, and one or more micro-features of the touch sensor may determine one or more optical features of the touch sensor, such as transmittance, refraction, or reflection.

A mechanical stack may contain the substrate (or multiple substrates) and the conductive material forming the drive or sense electrodes of touch sensor 10. As an example and not by way of limitation, the mechanical stack may include a first layer of optically clear adhesive (OCA) beneath a cover panel. The cover panel may be clear and made of a resilient material suitable for repeated touching, such as for example glass, polycarbonate, or poly(methyl methacrylate) (PMMA). This disclosure contemplates any suitable cover panel made of any suitable material. The first layer of OCA may be disposed between the cover panel and the substrate with the conductive material forming the drive or sense electrodes. The mechanical stack may also include a second layer of OCA and a dielectric layer (which may be made of PET or another suitable material, similar to the substrate with the conductive material forming the drive or sense electrodes). As an alternative, where appropriate, a thin coating of a dielectric material may be applied instead of the second layer of OCA and the dielectric layer. The second layer of OCA may be disposed between the substrate with the conductive material making up the drive or sense electrodes and the dielectric layer, and the dielectric layer may be disposed between the second layer of OCA and an air gap to a display of a device including touch sensor 10 and touch-sensor controller 12. As an example only and not by way of limitation, the cover panel may have a thickness of approximately 1 mm; the first layer of OCA may have a thickness of approximately 0.05 mm; the substrate with the conductive material forming the drive or sense electrodes may have a thickness of approximately 0.05 mm; the second layer of OCA may have a thickness of approximately 0.05 mm; and the dielectric layer may have a thickness of approximately 0.05 mm. Although this disclosure describes a particular mechanical stack with a particular number of particular layers made of particular materials and having particular thicknesses, this disclosure contemplates any suitable mechanical stack with any suitable number of any suitable layers made of any suitable materials and having any suitable thicknesses. As an example and not by way of limitation, in particular embodiments, a layer of adhesive or dielectric may replace the dielectric layer, second layer of OCA, and air gap described above, with there being no air gap to the display.

One or more portions of the substrate of touch sensor 10 may be made of polyethylene terephthalate (PET) or another suitable material. This disclosure contemplates any suitable substrate with any suitable portions made of any suitable material. In particular embodiments, the drive or sense electrodes in touch sensor 10 may be made of ITO in whole or in part. In particular embodiments, the drive or sense electrodes in touch sensor 10 may be made of fine lines of metal or other conductive material. As an example and not by way of limitation, one or more portions of the conductive material may be copper or copper-based and have a thickness of approximately 5 μm or less and a width of approximately 10 μm or less. As another example, one or more portions of the conductive material may be silver or silver-based and similarly have a thickness of approximately 5 μm or less and a width of approximately 10 μm or less. This disclosure contemplates any suitable electrodes made of any suitable material.

Touch sensor 10 may implement a capacitive form of touch sensing. In a mutual-capacitance implementation, touch sensor 10 may include an array of drive and sense electrodes forming an array of capacitive nodes. A drive electrode and a sense electrode may form a capacitive node. The drive and sense electrodes forming the capacitive node may come near each other, but not make electrical contact with each other. Instead, the drive and sense electrodes may be capacitively coupled to each other across a space between them. A pulsed or alternating voltage applied to the drive electrode (by touch-sensor controller 12) may induce a charge on the sense electrode, and the amount of charge induced may be susceptible to external influence (such as a touch or the proximity of an object). When an object touches or comes within proximity of the capacitive node, a change in capacitance may occur at the capacitive node and touch-sensor controller 12 may measure the change in capacitance. By measuring changes in capacitance throughout the array, touch-sensor controller 12 may determine the position of the touch or proximity within the touch-sensitive area(s) of touch sensor 10.

In a self-capacitance implementation, touch sensor 10 may include an array of electrodes of a single type that may each form a capacitive node. When an object touches or comes within proximity of the capacitive node, a change in self-capacitance may occur at the capacitive node and touch-sensor controller 12 may measure the change in capacitance, for example, as a change in the amount of charge needed to raise the voltage at the capacitive node by a pre-determined amount. As with a mutual-capacitance implementation, by measuring changes in capacitance throughout the array, touch-sensor controller 12 may determine the position of the touch or proximity within the touch-sensitive area(s) of touch sensor 10. This disclosure contemplates any suitable form of capacitive touch sensing, where appropriate.

In particular embodiments, one or more drive electrodes may together form a drive line running horizontally or vertically or in any suitable orientation. Similarly, one or more sense electrodes may together form a sense line running horizontally or vertically or in any suitable orientation. In particular embodiments, drive lines may run substantially perpendicular to sense lines. Herein, reference to a drive line may encompass one or more drive electrodes making up the drive line, and vice versa, where appropriate. Similarly, reference to a sense line may encompass one or more sense electrodes making up the sense line, and vice versa, where appropriate.

Touch sensor 10 may have drive and sense electrodes disposed in a pattern on one side of a single substrate. In such a configuration, a pair of drive and sense electrodes capacitively coupled to each other across a space between them may form a capacitive node. For a self-capacitance implementation, electrodes of only a single type may be disposed in a pattern on a single substrate. In addition or as an alternative to having drive and sense electrodes disposed in a pattern on one side of a single substrate, touch sensor 10 may have drive electrodes disposed in a pattern on one side of a substrate and sense electrodes disposed in a pattern on another side of the substrate. Moreover, touch sensor 10 may have drive electrodes disposed in a pattern on one side of one substrate and sense electrodes disposed in a pattern on one side of another substrate. In such configurations, an intersection of a drive electrode and a sense electrode may form a capacitive node. Such an intersection may be a location where the drive electrode and the sense electrode “cross” or come nearest each other in their respective planes. The drive and sense electrodes do not make electrical contact with each other—instead they are capacitively coupled to each other across a dielectric at the intersection. Although this disclosure describes particular configurations of particular electrodes forming particular nodes, this disclosure contemplates any suitable configuration of any suitable electrodes forming any suitable nodes. Moreover, this disclosure contemplates any suitable electrodes disposed on any suitable number of any suitable substrates in any suitable patterns.

As described above, a change in capacitance at a capacitive node of touch sensor 10 may indicate a touch or proximity input at the position of the capacitive node. Touch-sensor controller 12 may detect and process the change in capacitance to determine the presence and location of the touch or proximity input. Touch-sensor controller 12 may then communicate information about the touch or proximity input to one or more other components (such one or more central processing units (CPUs) or digital signal processors (DSPs)) of a device that includes touch sensor 10 and touch-sensor controller 12, which may respond to the touch or proximity input by initiating a function of the device (or an application running on the device) associated with it. Although this disclosure describes a particular touch-sensor controller having particular functionality with respect to a particular device and a particular touch sensor, this disclosure contemplates any suitable touch-sensor controller having any suitable functionality with respect to any suitable device and any suitable touch sensor.

Touch-sensor controller 12 may be one or more integrated circuits (ICs), such as for example general-purpose microprocessors, microcontrollers, programmable logic devices or arrays, application-specific ICs (ASICs). In particular embodiments, touch-sensor controller 12 comprises analog circuitry, digital logic, and digital non-volatile memory. In particular embodiments, touch-sensor controller 12 is disposed on a flexible printed circuit (FPC) bonded to the substrate of touch sensor 10, as described below. The FPC may be active or passive. In particular embodiments, multiple touch-sensor controllers 12 are disposed on the FPC. Touch-sensor controller 12 may include a processor unit, a drive unit, a sense unit, and a storage unit. The drive unit may supply drive signals to the drive electrodes of touch sensor 10. The sense unit may sense charge at the capacitive nodes of touch sensor 10 and provide measurement signals to the processor unit representing capacitances at the capacitive nodes. The processor unit may control the supply of drive signals to the drive electrodes by the drive unit and process measurement signals from the sense unit to detect and process the presence and location of a touch or proximity input within the touch-sensitive area(s) of touch sensor 10. The processor unit may also track changes in the position of a touch or proximity input within the touch-sensitive area(s) of touch sensor 10. The storage unit may store programming for execution by the processor unit, including programming for controlling the drive unit to supply drive signals to the drive electrodes, programming for processing measurement signals from the sense unit, and other suitable programming, where appropriate.

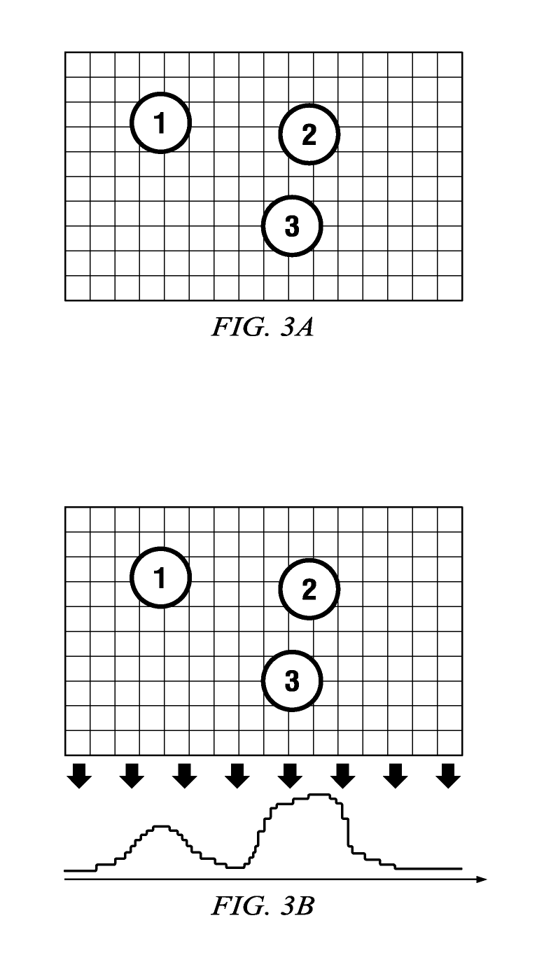

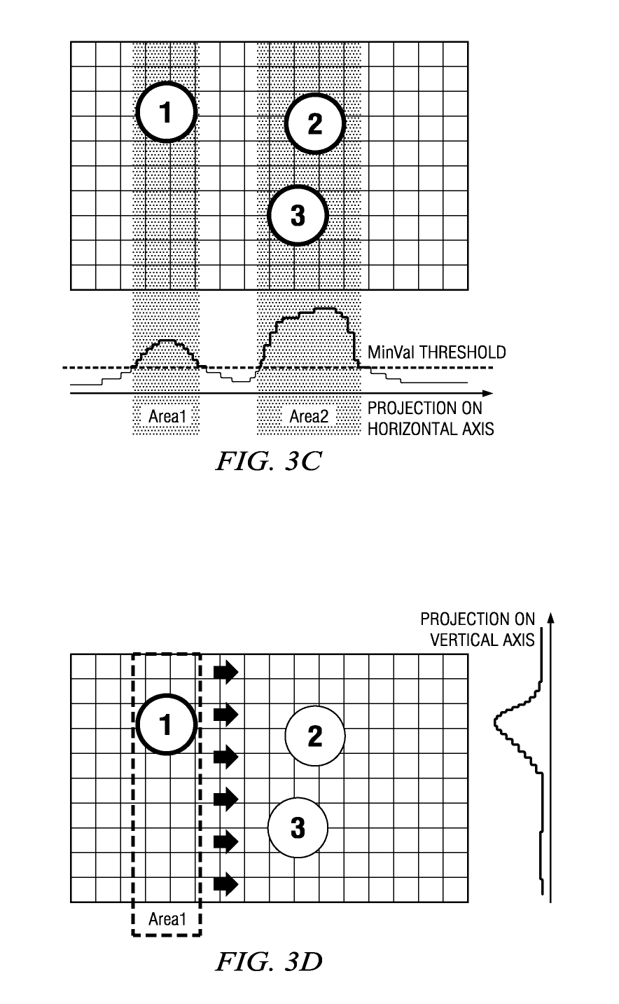

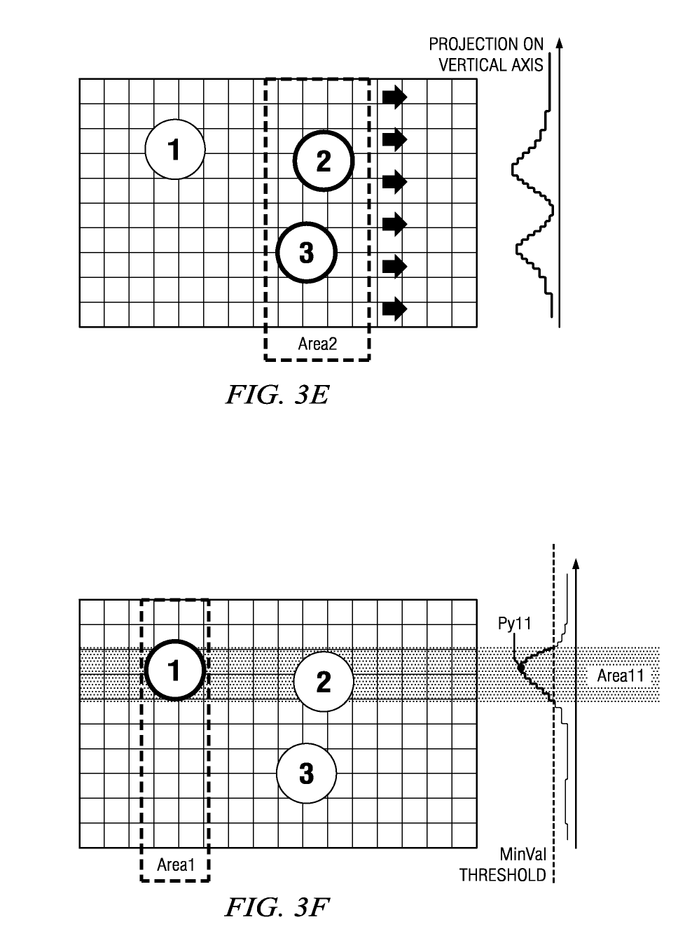

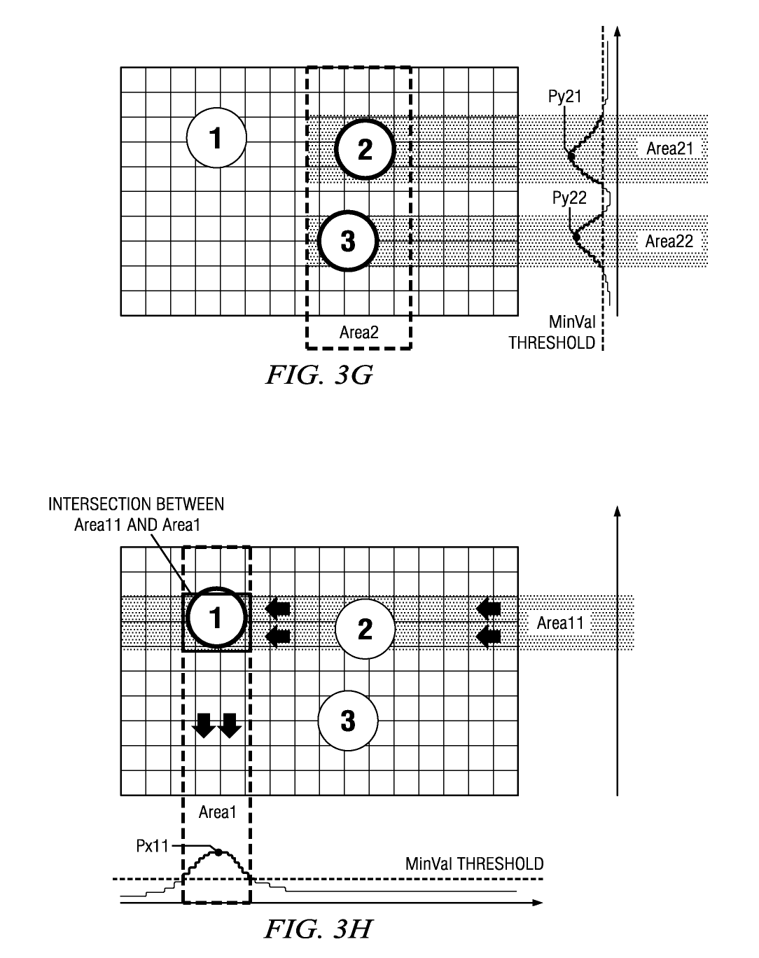

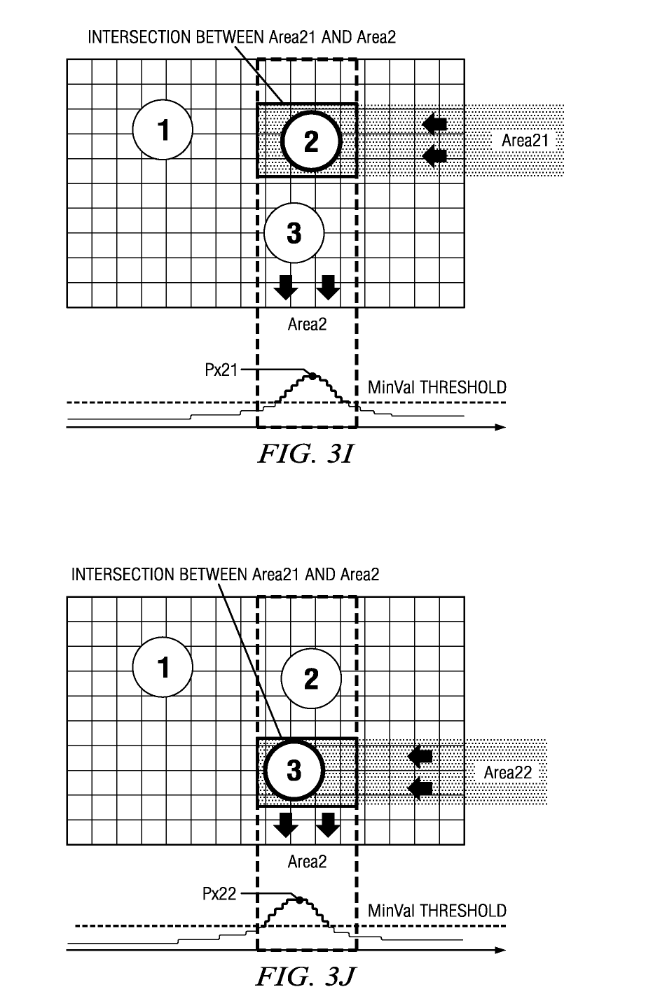

In some embodiments, touch-sensor controller 12 may be configured to detect touches by first determining a matrix of values corresponding to the measurements from touch sensor 10 discussed above. Touch-sensor controller 12 may then perform multiple calculations on one-dimensional arrays of data taken from the matrix of values to determine the coordinates of one or more touches detected by touch sensor 10. For example, the calculations may involve a series of vertical and/or horizontal projections and thresholding of those projections to detect the location(s) of touch(es). In some embodiments, such calculations may be an improvement over prior techniques performing calculations on two-dimensional arrays of data because techniques involving one-dimensional arrays of data may be executed faster, may require less memory resources, and/or may require less processing resources. Further examples of using calculations on one-dimensional arrays of data to determine the coordinates of touches on touch sensor 10 that may be used by touch-sensor controller 12 are given below with respect to FIGS. 2 and FIGS. 3A-3J.

Although this disclosure describes a particular touch-sensor controller having a particular implementation with particular components, this disclosure contemplates any suitable touch-sensor controller having any suitable implementation with any suitable components.

Tracks 14 of conductive material disposed on the substrate of touch sensor 10 may couple the drive or sense electrodes of touch sensor 10 to bond pads 16, also disposed on the substrate of touch sensor 10. As described below, bond pads 16 facilitate coupling of tracks 14 to touch-sensor controller 12. Tracks 14 may extend into or around (e.g. at the edges of) the touch-sensitive area(s) of touch sensor 10. Particular tracks 14 may provide drive connections for coupling touch-sensor controller 12 to drive electrodes of touch sensor 10, through which the drive unit of touch-sensor controller 12 may supply drive signals to the drive electrodes. Other tracks 14 may provide sense connections for coupling touch-sensor controller 12 to sense electrodes of touch sensor 10, through which the sense unit of touch-sensor controller 12 may sense charge at the capacitive nodes of touch sensor 10. Tracks 14 may be made of fine lines of metal or other conductive material. As an example and not by way of limitation, the conductive material of tracks 14 may be copper or copper-based and have a width of approximately 100 μm or less. As another example, the conductive material of tracks 14 may be silver or silver-based and have a width of approximately 100 μm or less. In particular embodiments, tracks 14 may be made of ITO in whole or in part in addition or as an alternative to fine lines of metal or other conductive material. Although this disclosure describes particular tracks made of particular materials with particular widths, this disclosure contemplates any suitable tracks made of any suitable materials with any suitable widths. In addition to tracks 14, touch sensor 10 may include one or more ground lines terminating at a ground connector (which may be a bond pad 16) at an edge of the substrate of touch sensor 10 (similar to tracks 14).

Bond pads 16 may be located along one or more edges of the substrate, outside the touch-sensitive area(s) of touch sensor 10. As described above, touch-sensor controller 12 may be on an FPC. Bond pads 16 may be made of the same material as tracks 14 and may be bonded to the FPC using an anisotropic conductive film (ACF). Connection 18 may include conductive lines on the FPC coupling touch-sensor controller 12 to bond pads 16, in turn coupling touch-sensor controller 12 to tracks 14 and to the drive or sense electrodes of touch sensor 10. This disclosure contemplates any suitable connection 18 between touch-sensor controller 12 and touch sensor 10.

FIG. 2 illustrates an example method for determining coordinates of one or more touches on a touch screen device using calculations on one-dimensional arrays of data. FIGS. 3A-3J illustrate an example of the operation of the method of FIG. 2 when three touches have been performed on a touch screen device. While the steps of FIG. 2 are discussed below using FIGS. 3A-3J as an example, the steps of FIG. 2 may be performed in other suitable manners as discussed further below. Particular embodiments may repeat the steps of the method of FIG. 2, where appropriate. Moreover, although this disclosure describes and illustrates particular steps of the method of FIG. 2 as occurring in a particular order, this disclosure contemplates any suitable steps of the method of FIG. 2 occurring in any suitable order. Furthermore, although this disclosure describes and illustrates particular components, devices, or systems carrying out particular steps of the method of FIG. 2, this disclosure contemplates any suitable combination of any suitable components, devices, or systems carrying out any suitable steps of the method of FIG. 2. FIGS. 3A-3J are intended to illustrate example operations to further understanding of disclosed embodiments and, thus, are not necessarily drawn to scale.

The method may start, in some embodiments, at step 200, where a one-dimensional representation along a horizontal axis of a touch device may be determined. For example, a touch sensor and touch-sensor controller of a touch screen device may operate to detect touches by acquiring mutual capacitance and/or self capacitance signals across drive and/or sense lines of the touch sensor. A two-dimensional array may be formed when using mutual capacitance signals. FIG. 3A depicts an example of three touches on a screen with m columns and n rows of electrodes. The array of values corresponding to the screen of FIG. 3A may be of [m,n] size and may be denoted as A[m,n].

As an example of determining the one-dimensional representation, signals values in each column may be added and a one-dimensional array of n elements may be formed with these sums. Hence, the two-dimensional array A[m,n] corresponding to the screen depicted in FIG. 3A may be used to determine a one-dimensional array B[m] where B[i]=(B[i,0]+B[i,1]+ . . . +B[i,n]). FIG. 3B illustrates an example of determining such a representation by summing column signal values.

In some embodiments, self capacitance measurements may be used. For example, the one-dimensional representation may be determined by measuring self capacitance signals and placing the measurements in a one-dimensional array. Using self capacitance measurements may, in some embodiments, reduce the number of required measurements.

At step 210, in some embodiments, it may be determined whether touch area(s) are detected in the one-dimensional representation determined at step 200. If touch areas are not detected, the method may end. If at least one touch area is detected, step 220 may be performed. One or more thresholds may be applied to the one-dimensional array of values when determining an area associated with a touch (a “touch area”). Touch areas may be determined using any suitable techniques. One example of determining a touch area may be determining a consecutive area of cells where: a local maximum is present, all cell values are above a first threshold, and each side is limited by either the beginning or the end of the array, a cell value that is below the threshold, or a cell with a local minimum value with suitable characteristics. In some embodiments, if a touch area has multiple local maximums, a second threshold may be used to determine whether the difference in value between a local minimum situated between two local maximums and each of the adjacent local maximums is great enough to cause a division of the touch area that includes the multiple local maximums into multiple touch areas including one of the local maximums. The first threshold may be related to the signal values of the weakest touch that is desired to be detected. For example, the value of the first threshold may be two times smaller than the value of a signal that results from the weakest touch that is desired to be detected.

An example of aspects of determining a touch area in an array containing signal values is now described. First, the maximum value of the entire array is determined. If the maximum value is above a threshold, the process may continue. If it is not, then it may be determined that the array does not include a touch area. The entries surrounding the maximum value are progressively analyzed (e.g., the cells to the left and to the right of the maximum value are first analyzed, and then the cells adjacent to those cells are analyzed next). Once a cell has a value that is greater than the value of adjacent cell that has already been analyzed, a border for the touch area may be determined. In this manner, borders for the touch area that includes the maximum value may be determined. All of the cells within the borders may be marked.

Next, a scan of the unmarked cells of the array may be performed. The scan searches for the maximum value in the unmarked cells and compares it to the threshold. If the maximum value is at or below the threshold, then the process is complete. If the maximum value of the unmarked cells is above the threshold, then the entries surrounding the maximum value are progressively analyzed as discussed above to determine the borders of the touch area that includes the maximum value of the unmarked cells. All of the entries within the determined borders may be marked. The remaining unmarked cells of the array may again be scanned to search for a maximum value that is above the threshold and the process may repeat until all cells or marked or until the maximum value of the unmarked cells is not above the threshold. In some embodiments, suitable variations of the examples discussed above may be performed when determining touch areas.

FIG. 3C provides an example of aspects of detecting touch areas. There, a threshold titled “MinVal THRESHOLD” is used to detect areas where touches occurred in the one-dimensional representation. The example illustration of FIG. 3C depicts two touch areas, Area1 and Area2, in the one-dimensional representation that correspond to the three touches present on the device.

At step 220, in some embodiments, one-dimensional representation(s) along the vertical axis of touch area(s) are determined. For example, for each of the touch areas determined at step 210, a one-dimensional representation along the vertical axis may be determined that only includes the cells of the touch area(s) determined at step 210. In some embodiments, a scan of the screen may occur at this step. Mutual capacitance or self-capacitance measurements may be performed to implement the scan. When using mutual capacitance measurements, the one-dimensional representation along the vertical axis may be determined by summing the row values in the each of the areas and storing the sums in one-dimensional arrays. When using self capacitance measurements, the one-dimensional array may be formed from the self capacitance measurements directly. Each one-dimensional array may correspond to one of the touch areas determined at step 210.

FIGS. 3D and 3E serve as examples of the one-dimensional representations along the vertical axis for the touch areas illustrated in FIG. 3C. FIG. 3D is an example of the one-dimensional representation along the vertical axis of Area1 and FIG. 3E is an example of the one-dimensional representation along the vertical axis of Area2.

At step 230, in some embodiments, it may be determined whether any touch areas are detected in the one-dimensional representations along the vertical axis determined at step 220. If any touch areas are detected in the one-dimensional representations along the vertical axis, then step 240 is performed. If not, then the method may end. The touch areas may be determined using any of the examples discussed above at step 210.

FIGS. 3F and 3G illustrate examples of applying thresholds in the one-dimensional representation along the vertical axis as part of the process of determining touch areas in the one-dimensional representations along the vertical axis. In FIG. 3F, MinVal THRESHOLD is applied to the one-dimensional representation along the vertical axis of Area1 and Area11 is determined to correspond to a touch. In FIG. 3G, MinVal THRESHOLD is applied to the one-dimensional representation along the vertical axis of Area1 and Area21 and Area22 are determined to correspond to separate touches.

In some embodiments, the center(s) of the touch areas determined in the one-dimensional representations may also be calculated at this step. For example, centroid calculation techniques may be used to determine the center(s) of the touch areas. As another example, a weighted average may be used. Other suitable techniques may be used. In FIGS. 3F and 3G, for example, the centers of the touch areas are labeled Py11, Py21 and Py22. A formula that may be used, in some embodiments, is:

$$PositionY = K \frac{{\sum }_{{m}_{2}}^{j = {m}_{1}} {\sum }_{{n}_{2}}^{j = {n}_{1}} {α}_{ij} * j * ( {S}_{ij} - {S}_{min} )}{{\sum }_{{m}_{2}}^{j = {m}_{1}} {\sum }_{{n}_{2}}^{j = {n}_{1}} {α}_{ij} * ( {S}_{ij} - {S}_{min} )}$$

where:
m1 is the start number of the row of the touch area for which the center is being determined;

m2 is the end number of the row of the touch area for which the center is being determined;

n1 is the start number of the column of the touch area for which the center is being determined;

n2 is the end number of the column of the touch area for which the center is being determined;
αᵢⱼ is equal to 1 if the signal in the cell corresponding to row j and column i has a value greater than the threshold (e.g., MinVal THRESHOLD of FIG. 3F) and 0 if the value is less than or equal to the threshold;
Sᵢⱼ is the signal value at row j and column i;
Sₘᵢₙ is the minimum value for all cells in the touch area for which the center is being determined;
K is a scaling coefficient. As an example, a K value of 256 will result in a change of positions between two measuring electrodes of 256 counts.

In some embodiments, Sₘᵢₙ is not subtracted from Sᵢⱼ if Sₘᵢₙ is significantly smaller than the threshold (e.g., MinVal THRESHOLD of FIG. 3F).

At step 240, in some embodiments, one-dimensional representations along the horizontal axis of intersecting touch areas determined from steps 210 and 230 are determined. For example, a one-dimensional representation along the horizontal axis may be determined for each intersecting area of the touch areas determined at steps 210 and 230 (e.g., the intersections between Area1, Area2, Area11, Area21, and Area22 of FIGS. 3C, 3F and 3G). In some embodiments, a scan of the screen may occur at this step. Mutual capacitance or self-capacitance measurements may be performed to implement the scan.

Examples of the one-dimensional representations along the horizontal axis are depicted in FIGS. 3H-3J. FIG. 3H depicts the one-dimensional representation of the intersection of Area1 and Area11. FIG. 3I depicts the one-dimensional representation of the intersection of Area2 and Area21. FIG. 3J depicts the one-dimensional representation of the intersection of Area2 and Area22. An example of determining the one-dimensional representation along the horizontal axis at this step is adding values in the columns in the determined intersecting area creating one-dimensional arrays of values. Each of the arrays may correspond to one of the intersecting areas.

At step 240, in some embodiments, touch areas within the one-dimensional representations determined at step 220 may be determined. This may be done, for example, to detect if there are other touch areas within the intersection of the touch areas determined at steps 210 and 230. Determining touch areas in the one-dimensional representations at step 240 may be implemented using any of the examples discussed above regarding determining touch areas at step 210.

FIGS. 3H-3J illustrate examples of applying thresholds to the one-dimensional arrays of values along the horizontal axis as part of determining touch areas in the one-dimensional representations along the horizontal axis of intersections of the touch areas determined at steps 210 and 230. In FIG. 3H, MinVal THRESHOLD is applied to the one-dimensional representation along the horizontal axis of the intersection of Area1 and Area11. In FIG. 31, MinVal THRESHOLD is applied to the one-dimensional representation along the horizontal axis of the intersection of Area2 and Area21. In FIG. 3J, MinVal THRESHOLD is applied to the one-dimensional representation along the horizontal axis of the intersection of Area2 and Area22. The portions above the threshold in FIGS. 3H-3J may correspond to detected touch areas.

In some embodiments, the center(s) of the detected touch areas determined by applying one or more thresholds to the one-dimensional representations of the intersections may also be calculated at this step. For example, centroid calculation techniques may be used to determine the center(s) of the touch areas. As another example, a weighted average may be used. Other suitable techniques may be used. In FIGS. 3H-3J, for example, the centers of the touch areas are labeled Px11, Px21 and Px22. A formula that may be used, in some embodiments, is:

$$PositionX = K \frac{{\sum }_{{m}_{2}}^{j = {m}_{1}} {\sum }_{{n}_{2}}^{j = {n}_{1}} {α}_{ij} * i * ( {S}_{ij} - {S}_{min} )}{{\sum }_{{m}_{2}}^{j = {m}_{1}} {\sum }_{{n}_{2}}^{j = {n}_{1}} {α}_{ij} * ( {S}_{ij} - {S}_{min} )}$$

where:
m1 is the start number of the row of the touch area for which the center is being determined;
m2 is the end number of the row of the touch area for which the center is being determined;
n1 is the start number of the column of the touch area for which the center is being determined;
n2 is the end number of the column of the touch area for which the center is being determined;

αᵢⱼ is equal to 1 if the signal in the cell corresponding to row j and column i has a value greater than the threshold (e.g., MinVal THRESHOLD of FIG. 3H) and 0 if the value is less than or equal to the threshold;

Sᵢⱼ is the signal value at row j and column i;

Sₘᵢₙ is the minimum value for all cells in the touch area for which the center is being determined;

K is a scaling coefficient. As an example, a K value of 256 will result in a change of positions between two measuring electrodes of 256 counts. In some embodiments, Sₘᵢₙ is not subtracted from Sᵢⱼ if Sₘᵢₙ is significantly smaller than the threshold (e.g., MinVal THRESHOLD of FIG. 3H).

At step 250, in some embodiments, coordinates may be determined, at which point the method may end. This may be done by using the information determined at steps 210, 230, and 240. For example, the center of the touch areas determined at steps 210, 230, and 240 may be used as coordinates. As applied to FIGS. 3A-3J, the coordinates determined at this step may be:
Touch 1: X=Px11; Y=Py11
Touch 2: X=Px21; Y=Py21
Touch 3: X=Px22; Y=Py22

The coordinates may be stored or sent to one or more components of the touch screen device, such as memory or processing elements of the touch screen device.

In some embodiments, one or more steps may be repeated before step 250 is performed. For example, the touch areas detected at step 240 may be used as initial data for step 220 and steps 220-240 may be repeated. While the steps above describe one-dimensional representations along the horizontal and vertical axes, the steps may be used with other forms of suitable one-dimensional representations. In some embodiments, the steps may be performed in other suitable orders. For example, while a one-dimensional representation along the horizontal axis is described as occurring before a one-dimensional representation along the vertical axis above, one-dimensional representations along the vertical axis may be performed at step 200, one-dimensional representations along the horizontal axis may be performed at step 220, and one-dimensional representations along the vertical axis may be performed at step 240.

In some embodiments, step 240 may not be performed. For example, if a touch device is used to detect only one touch at a time, then step 240 may not be performed. When step 240 is not performed, step 250 may be performed using the information from steps 210 and 230. Center(s) of detected touch areas in steps 210 and 230 may be calculated as discussed above and may be used to determine coordinates at step 250.

Depending on the specific features implemented, particular embodiments may exhibit some, none, or all of the following technical advantages. Detection of touches may be performed faster and with less resources (e.g., memory and/or processing resources). Complex two-dimensional algorithms that involve recursive operations may be avoided. In some embodiments, detecting touches in a two-dimensional space may be reduced to a series of one-dimensional operations. The embodiments described above may be recursive allowing for increasing levels of granularity of detection. The techniques described above may allow for the implementation of multitouch capacitive screens as they provide examples of calculating the positions of touches that occur simultaneously. Other technical advantages will be readily apparent to one skilled in the art from the preceding figures and description as well as the proceeding claims. Particular embodiments may provide or include all the advantages disclosed, particular embodiments may provide or include only some of the advantages disclosed, and particular embodiments may provide none of the advantages disclosed.

Herein, reference to a computer-readable non-transitory storage medium may encompass a semiconductor-based or other integrated circuit (IC) (such, as for example, a field-programmable gate array (FPGA) or an application-specific IC (ASIC)), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a suitable combination of two or more of these, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

This disclosure encompasses all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

What is claimed is:

1. A method, performed by executing logic embodied by one or more computer-readable non-transitory storage media, comprising:
receiving a first set of signal values from a touch sensor, the touch sensor comprising a plurality of electrodes;
storing the first set of signal values in a first two-dimensional array;
determining a first one-dimensional representation associated with a first axis of the first two-dimensional array;
determining a first area associated with at least one touch detected by the touch sensor from the first one-dimensional representation;
determining a second one-dimensional representation associated with a second axis based on the first area, the second axis being different than the first axis;
determining a second area associated with at least one touch detected by the touch sensor from the second one-dimensional representation; and
determining coordinates for the at least one touch detected by the touch sensor based on the first area and the second area.

2. The method of claim 1, further comprising:
determining an intersection area between the first area and the second area;
determining a third one-dimensional representation associated with the first axis based on the intersection area;
determining a third area associated with at least one touch detected by the touch sensor from the third one-dimensional representation; and
wherein determining coordinates for the at least one touch detected by the touch sensor based on the first area and the second area comprises determining coordinates for the at least one touch detected by the touch sensor based on the first area, the second area, and the third area.

3. The method of claim 1, wherein determining the second one-dimensional representation associated with the second axis based on the first area comprises:
receiving a second set of signal values from the touch sensor;
storing the second set of signal values in a second two-dimensional array; and
determining the second one-dimensional representation associated with the second axis based on the second two-dimensional array.

4. The method of claim 1, wherein determining the first area associated with the at least one touch detected by the touch sensor from the first one-dimensional representation comprises comparing values stored in the first one-dimensional representation to at least one threshold.

5. The method of claim 1, wherein determining coordinates for the at least one touch detected by the touch sensor based on the first area and the second area comprises:
determining a first weighted average of values associated with the first area;
determining a second weighted average of values associated with the second area; and
determining the coordinates for the at least one touch based on the first weighted average and the second weighted average.

6. The method of claim 1, wherein each value of the first one-dimensional representation associated with the first axis of the first two-dimensional array is associated with a column of values in the first two-dimensional array.

7. The method of claim 1, wherein:
the first axis is a horizontal axis; and
the second axis is a vertical axis.

8. An apparatus comprising:
a first set of lines, each line of the first set of lines comprising electrodes;
a second set of lines, each line of the second set of lines comprising electrodes, the second set of lines capacitively coupled to the first set of lines; and
one or more computer-readable non-transitory storage media comprising logic that, when executed is operable to:
receive a first set of signal values from the first set of lines;
store the first set of signal values in a first two-dimensional array;
determine a first one-dimensional representation associated with a first axis of the first two-dimensional array;
determine a first area associated with at least one touch detected by the touch sensor from the first one-dimensional representation;
determine a second one-dimensional representation associated with a second axis based on the first area, the second axis being different than the first axis;
determine a second area associated with at least one touch detected by the first set of lines from the second one-dimensional representation; and
determine coordinates for the at least one touch detected by the first set of lines based on the first area and the second area.

9. The apparatus of claim 1, wherein:
the logic is further operable to:
determine an intersection area between the first area and the second area;
determine a third one-dimensional representation associated with the first axis based on the intersection area; and
determine a third area associated with at least one touch detected by the first set of lines from the third one-dimensional representation; and
the logic is operable to determine coordinates for the at least one touch detected by the first set of lines based on the first area and the second area by determining coordinates for the at least one touch detected by the first set of lines based on the first area, the second area, and the third area.

10. The apparatus of claim 8, wherein the logic is operable to determine the second one-dimensional representation associated with the second axis based on the first area by:
receiving a second set of signal values from the first set of lines;
storing the second set of signal values in a second two-dimensional array; and
determining the second one-dimensional representation associated with the second axis based on the second two-dimensional array.

11. The apparatus of claim 8, wherein the logic is operable to determine the first area associated with the at least one touch detected by the first set of lines from the first one-dimensional representation by comparing values stored in the first one-dimensional representation to at least one threshold.

12. The apparatus of claim 8, wherein the logic is operable to determine coordinates for the at least one touch detected by the first set of lines based on the first area and the second area by:
determining a first weighted average of values associated with the first area;
determining a second weighted average of values associated with the second area; and
determining the coordinates for the at least one touch based on the first weighted average and the second weighted average.

13. The apparatus of claim 8, wherein each value of the first one-dimensional representation associated with the first axis of the first two-dimensional array is associated with a column of values in the first two-dimensional array.

14. The apparatus of claim 8, wherein:
the first axis is a horizontal axis; and
the second axis is a vertical axis.

15. One or more computer-readable non-transitory storage media comprising logic that, when executed is operable to:
receive a first set of signal values from a touch sensor, the touch sensor comprising a plurality of electrodes;
store the first set of signal values in a first two-dimensional array;
determine a first one-dimensional representation associated with a first axis of the first two-dimensional array;
determine a first area associated with at least one touch detected by the touch sensor from the first one-dimensional representation;
determine a second one-dimensional representation associated with a second axis based on the first area, the second axis being different than the first axis;
determine a second area associated with at least one touch detected by the touch sensor from the second one-dimensional representation; and
determine coordinates for the at least one touch detected by the touch sensor based on the first area and the second area.

16. The media of claim 15, wherein:
the logic is further operable to:
determine an intersection area between the first area and the second area;
determine a third one-dimensional representation associated with the first axis based on the intersection area; and
determine a third area associated with at least one touch detected by the touch sensor from the third one-dimensional representation; and
the logic is operable to determine coordinates for the at least one touch detected by the touch sensor based on the first area and the second area by determining coordinates for the at least one touch detected by the touch sensor based on the first area, the second area, and the third area.

17. The media of claim 15, wherein the logic is operable to determine the second one-dimensional representation associated with the second axis based on the first area by:
receiving a second set of signal values from the touch sensor;
storing the second set of signal values in a second two-dimensional array; and
determining the second one-dimensional representation associated with the second axis based on the second two-dimensional array.

18. The media of claim 15, wherein the logic is operable to determine the first area associated with the at least one touch detected by the touch sensor from the first one-dimensional representation by comparing values stored in the first one-dimensional representation to at least one threshold.

19. The media of claim 15, wherein the logic is operable to determine coordinates for the at least one touch detected by the touch sensor based on the first area and the second area by:
determining a first weighted average of values associated with the first area;
determining a second weighted average of values associated with the second area; and
determining the coordinates for the at least one touch based on the first weighted average and the second weighted average.

20. The media of claim 15, wherein each value of the first one-dimensional representation associated with the first axis of the first two-dimensional array is associated with a column of values in the first two-dimensional array.

21. The media of claim 15, wherein:
the first axis is a horizontal axis; and
the second axis is a vertical axis.
